(19) United States
(12) Patent Application Publication
(10) Pub. No.: US 2026/0106392 A1
(43) Pub. Date: Apr. 16, 2026

(54) WRITE PROTECTION FOR EEPROM OF A PLUGGABLE COMMUNICATION MODULE

(71) Applicants: TE Connectivity Solutions GmbH, Schaffhausen (CH); TYCO ELECTRONICS (SHANGHAI) CO., Ltd., Shanghai (CN)

(72) Inventors: Brian Patrick Costello, Fremont, CA (US); Songhua Liu, Dongguan (CN); Joel Nathan Meyers, Middletown, PA (US); Drew Flickinger, Middletown, PA (US)

(21) Appl. No.: 18/911,972

(22) Filed: Oct. 10, 2024

(51) Int. Cl. H01R 12/72; G11C 16/10; G11C 16/32; H01R 12/70

(52) U.S. Cl. CPC H01R 12/721; H01R 12/7005; G11C 16/10; G11C 16/32

(57) ABSTRACT

A pluggable communication module includes a circuit card having a substrate with an edge. The pluggable communication module includes an EEPROM device having a power supply pin, a serial data pin, a serial clock pin, a ground pin, and a write control pin for programming the EEPROM device. The pluggable communication module includes a contact pad field proximate to the edge having signal pads, ground pads, a power pad, a serial data pad, a serial clock pad, and a write pad. The write pad is located at a programming depth from the edge of the circuit card forward of the signal pads to mate the write pad to the receptacle connector without mating to the signal pads to the receptacle connector.

### BACKGROUND OF THE INVENTION

The subject matter herein relates generally to data communication systems.

Some communication systems utilize communication connectors, such as card edge connectors to interconnect various components of the system for data communication. Some known communication systems use pluggable communication modules, such as I/O modules or circuit cards, which are electrically connected to the card edge connectors. The pluggable communication module has a circuit card having a card edge that is mated with the card edge connector during a mating operation.

Some known pluggable communication modules include EEPROM devices on the circuit card to store information about the pluggable communication module. It is important that the data on the EEPROM device does not get corrupted and/or modified so most devices have the capability to write protect the data. Typically, one of the pins at the connector interface is connected to the write control pin of the EEPROM device to control the write protect/enable function of the EEPROM device. However, this takes up a position in the connector. Some connectors do not have a spare pin that can be assigned to the write protection function. Other known devices use a write connect input that can be left in an open state during production and then connected to the power supply once written. However, this requires that the device be disassembled to write to it, which is not desirable from a manufacturing process standpoint. Other known devices use write protect software in the EEPROM device that allows a software code to be used to enable writing to the EEPROM. However, such devices have proved problematic as the enable code can be inadvertently written and the EEPROM data corrupted. In other various embodiments, a communication switch, such as an I2C I/O expander, can be added to the device that would be used to control the write protect/enable of the EEPROM device. However, this adds an additional component and also requires an additional I/O address, which is a problem as the device typically only has one address to be used to communicate with the EEPROM and address conflicts could occur when an additional device with a different address is present. Other known devices utilize a separate switch added to the device that is externally accessible to control the write protect/enable function. However, such systems have significant added cost associated with such approach and the switch could be accidentally set to write, which could be problematic.

A need remains for a reliable and cost-effective write protection method for a pluggable communication module having an EEPROM device.

### BRIEF DESCRIPTION OF THE INVENTION

In one embodiment, a pluggable communication module configured to be plugged into a receptacle connector is provided. The pluggable communication module includes a circuit card that includes a substrate having an upper surface and a lower surface. The substrate has an edge. The pluggable communication module includes an EEPROM device mounted to the upper surface of the substrate. The EEPROM device includes a power supply pin, a serial data pin, a serial clock pin, a ground pin, and a write control pin for programming the EEPROM device. The pluggable communication module includes a contact pad field on the upper surface of the substrate proximate to the edge. The contact pad field includes signal pads, ground pads, a power pad, a serial data pad, a serial clock pad, and a write pad. The power pad is electrically connected to the power supply pin of the EEPROM device. The serial data pad is electrically connected to the serial data pin of the EEPROM device. The serial clock pad is electrically connected to the serial clock pin of the EEPROM device. A programming ground pad of the ground pads is electrically connected to the ground pin of the EEPROM device. The write pad is electrically connected to the write control pin of the EEPROM device. The write pad is located at a programming depth from the edge of the circuit card forward of the signal pads to mate the write pad to the receptacle connector without mating to the signal pads to the receptacle connector.

In another embodiment, a pluggable communication module configured to be plugged into a receptacle connector is provided. The pluggable communication module includes a circuit card that includes a substrate having an upper surface and a lower surface. The substrate has an edge. The pluggable communication module includes an EEPROM device mounted to the upper surface of the substrate. The EEPROM device includes a power supply pin, a serial data pin, a serial clock pin, a ground pin, and a write control pin for programming the EEPROM device. The pluggable communication module includes a contact pad field on the upper surface of the substrate proximate to the edge. The contact pad field includes signal pads, ground pads, a power pad, a serial data pad, a serial clock pad, and a write pad. The power pad is electrically connected to the power supply pin of the EEPROM device. The serial data pad is electrically connected to the serial data pin of the EEPROM device. The serial clock pad is electrically connected to the serial clock pin of the EEPROM device. A programming ground pad of the ground pads is electrically connected to the ground pin of the EEPROM device. The write pad is electrically connected to the write control pin of the EEPROM device. The power pad, the serial data pad, the serial clock pad, and the programming ground pad are located at a programming depth from the edge of the circuit card forward of the signal pads to mate the power pad, the serial data pad, and the serial clock pad to the receptacle connector without mating to the signal pads to the receptacle connector. The write pad is configured to mate with a programming probe to program the EEPROM device.

In a further embodiment, a communication system is provided and includes a receptacle connector that includes a connector housing having a cavity, contacts received in the cavity and held by the housing. Each contact includes a contact beam that has a mating interface. The mating interfaces of the contacts are arranged in a row. The connector housing includes an opening to the cavity. The communication system includes a pluggable communication module plugged into the opening to mate with the contacts. The pluggable communication module includes a circuit card that includes a substrate having an upper surface and a lower surface. The substrate has an edge configured to be plugged into the opening of the connector housing. The pluggable communication module includes an EEPROM device mounted to the upper surface of the substrate. The EEPROM device includes a power supply pin, a serial data pin, a serial clock pin, a ground pin, and a write control pin for programming the EEPROM device. The pluggable communication module includes a contact pad field on the upper surface of the substrate proximate to the edge. The contact pad field includes signal pads, ground pads, a power pad, a serial data pad, a serial clock pad, and a write pad configured to be mated with the contacts when the pluggable communication module is plugged into the receptacle connector. The power pad is electrically connected to the power supply pin of the EEPROM device. The serial data pad is electrically connected to the serial data pin of the EEPROM device. The serial clock pad is electrically connected to the serial clock pin of the EEPROM device. A programming ground pad of the ground pads is electrically connected to the ground pin of the EEPROM device. The write pad is electrically connected to the write control pin of the EEPROM device. The write pad is located at a programming depth from the edge of the circuit card forward of the signal pads. The pluggable communication module is pluggable into the opening to a programming position to mate the write pad to the receptacle connector without mating to the signal pads to the receptacle connector.

### BRIEF DESCRIPTION OF THE DRAWINGS

FIG. 1 is a front perspective view of a communication system in accordance with an exemplary embodiment.

FIG. 2 is a front perspective view of a portion of the communication system in accordance with an exemplary embodiment.

FIG. 3 is a front perspective view of the pluggable communication module in accordance with an exemplary embodiment.

FIG. 4 illustrates the circuit card in accordance with an exemplary embodiment.

FIG. 5 is a sectional view of the communication system in accordance with an exemplary embodiment showing the circuit card of the pluggable communication module poised for loading into the receptacle connector.

FIG. 6 is a sectional view of the communication system in accordance with an exemplary embodiment showing the circuit card of the pluggable communication module partially loaded into the receptacle connector to a programming depth.

FIG. 7 is a sectional view of the communication system in accordance with an exemplary embodiment showing the circuit card of the pluggable communication module loaded into the receptacle connector to a full mate depth.

FIG. 8 is a top view of the communication system in accordance with an exemplary embodiment showing the circuit card of the pluggable communication module unmated with the contact array of contacts of the receptacle connector (corresponding to FIG. 5).

FIG. 9 is a top view of the communication system in accordance with an exemplary embodiment showing the circuit card of the pluggable communication module partially mated with the contact array of contacts of the receptacle connector at the programming depth (corresponding to FIG. 6).

FIG. 10 is a top view of the communication system in accordance with an exemplary embodiment showing the circuit card of the pluggable communication module mated with the contact array of contacts of the receptacle connector at the full mate depth (corresponding to FIG. 7).

FIG. 11 illustrates the circuit card in accordance with an exemplary embodiment showing a different arrangement of the contacts.

FIG. 12 is a sectional view of the communication system in accordance with an exemplary embodiment showing the circuit card of FIG. 11 partially loaded into the receptacle connector to a programming depth.

### DETAILED DESCRIPTION OF THE INVENTION

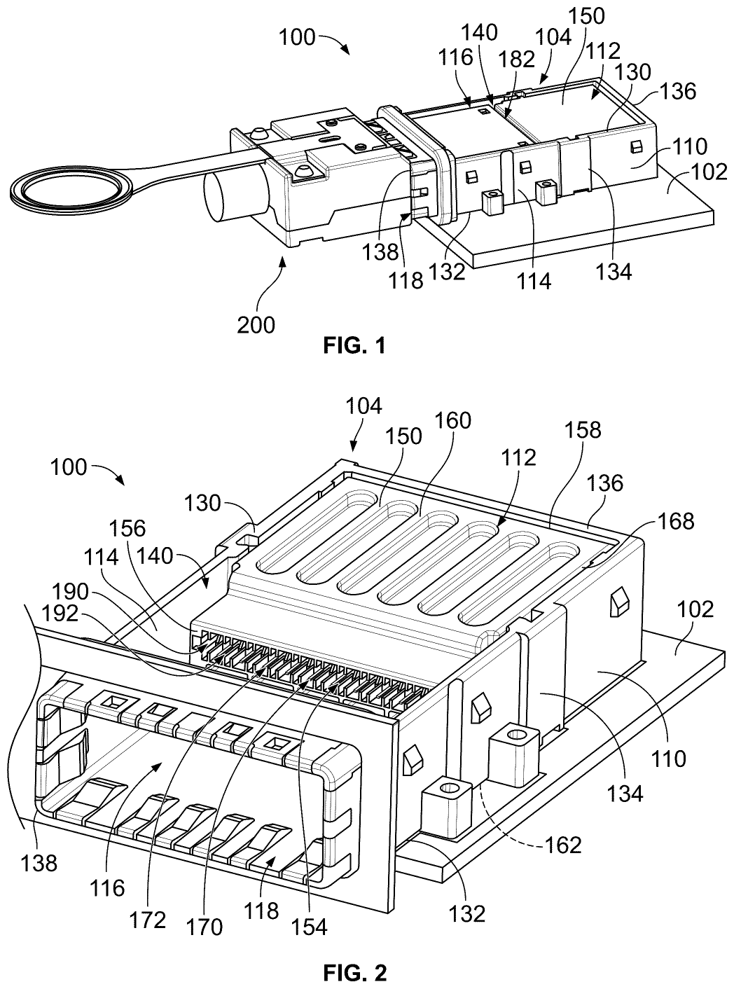

FIG. 1 is a front perspective view of a communication system 100 in accordance with an exemplary embodiment. FIG. 2 is a front perspective view of a portion of the communication system 100 in accordance with an exemplary embodiment. The communication system 100 includes a circuit board 102 and a receptacle connector assembly 104 mounted to the circuit board 102. A pluggable communication module 200 (FIG. 1) is configured to be electrically connected to the receptacle connector assembly 104. The pluggable communication module 200 is removed in FIG. 2 to illustrate components of the receptacle connector assembly 104. The pluggable communication module 200 is electrically connected to the circuit board 102 through the receptacle connector assembly 104. In an exemplary embodiment, the pluggable communication module 200 is an input/output (I/O) module, such as a transceiver module. In other various embodiments, the pluggable communication module 200 may be a circuit card or paddle card rather than an I/O module.

The receptacle connector assembly 104 may be utilized for data communication within the communication system 100. For example, the receptacle connector assembly 104 may be coupled to other components within the communication system 100 through the circuit board 102. In various embodiments, the receptacle connector assembly 104 may be used during production of the pluggable communication module 200 for testing and/or programming the pluggable communication module 200. For example, the pluggable communication module 200 may include a memory device, such as an EEPROM device, which may be programmed during production and/or tested during production using the receptacle connector assembly 104. During testing, the EEPROM device may function in a write enabled mode to allow writing or programming of the EEPROM device. During normal use of the pluggable communication module 200 in the communication system 100, the EEPROM device functions in a write disabled mode (or write protect mode) to protect the data stored on the EEPROM device from being corrupted and/or modified.

In an exemplary embodiment, the receptacle connector assembly 104 includes a receptacle cage 110 and a receptacle connector 112 adjacent the receptacle cage 110. For example, in the illustrated embodiment, the receptacle connector 112 is received in the receptacle cage 110. In other various embodiments, the receptacle connector 112 may be located rearward of the receptacle cage 110. In alternative embodiments, the receptacle connector assembly 104 is provided without the receptacle cage 110. For example, the receptacle connector 112 may be provided without the surrounding receptacle cage 110. In various embodiments, the receptacle connector 112 is a card edge connector.

In various embodiments, the receptacle cage 110 is enclosed and provides electrical shielding for the receptacle connector 112. The pluggable communication module 200 is loaded into the receptacle cage 110 and is at least partially surrounded by the receptacle cage 110. The receptacle cage 110 includes a plurality of walls 114 that define one or more module channels for receipt of corresponding pluggable communication module(s) 200. The walls 114 may be walls defined by solid sheets, perforated walls to allow airflow therethrough, walls with cutouts, such as for a heatsink or heat spreader to pass therethrough, or walls defined by rails or beams with relatively large openings. In an exemplary embodiment, the receptacle cage 110 is a shielding, die cast metallic cage member with the walls 114 being shielding walls 114. In other embodiments, the receptacle cage 110 may be open between frame members, such as rails or beams, to provide cooling airflow for the pluggable communication module 200 with the frame members of the receptacle cage 110 defining guide tracks for guiding loading of the pluggable communication module 200 into the receptacle cage 110.

In the illustrated embodiment, the receptacle cage 110 is a single port cage configured to receive a single pluggable communication module 200 in a single module channel 116. However, in alternative embodiments, the receptacle cage 110 may include multiple ports to receive multiple pluggable communication modules, such as being a stacked cage member having upper and lower module channels 116. The module channels may be arranged in a single column, however, the receptacle cage 110 may include multiple columns of ganged module channels in alternative embodiments (for example, 2×2, 3×2, 4×2, 4×3, etc.). The receptacle cage 110 includes a port 118 providing access to the module channel 116. The pluggable communication module 200 is plugged into the module channel 116 through the port 118. Optionally, multiple receptacle connectors 112 may be arranged within the receptacle cage 110 to mate with the multiple pluggable communication modules.

In an exemplary embodiment, the walls 114 of the receptacle cage 110 include a top wall 130, a bottom wall 132, and side walls 134 extending between the top wall 130 and the bottom wall 132. The bottom wall 132 may rest on the circuit board 102. However, in alternative embodiments, the bottom wall 132 may be elevated a distance above the circuit board 102 defining a gap below the bottom wall 132, such as for airflow. In other various embodiments, the receptacle cage 110 may be provided without the bottom wall 132. Optionally, the walls 114 of the receptacle cage 110 may include a rear wall 136 and a front wall 138 at the front of the receptacle cage 110. The module port 118 is provided in the front wall 138. The walls 114 define a cavity 140, which forms the module channel(s) 116. The cavity 140 is defined by the top wall 130, the bottom wall 132, the side walls 134, the rear wall 136 and the front wall 138. Other walls 114 may separate or divide the cavity 140 into various module channels 116. For example, the walls 114 may include a channel separator between upper and lower module channels 116. The walls 114 may include divider walls, parallel to the side walls 134, extending between the top wall 130 and the bottom wall 132 to separate adjacent module channels from each other.

In an exemplary embodiment, the receptacle cage 110 may include one or more gaskets at the front wall 138 for providing electrical shielding for the module channel 116. For example, the gaskets may be configured to electrically connect with the pluggable communication module 200 received in the module channel 116. The gaskets may be configured to electrically connect to a panel or bezel.

In an exemplary embodiment, the pluggable communication module 200 is loaded through the front wall 138 to mate with the receptacle connector 112. The shielding walls 114 of the receptacle cage 110 provide electrical shielding around the receptacle connector 112 and the pluggable communication module 200, such as around the mating interfaces between the receptacle connector 112 and the pluggable communication module 200.

In an exemplary embodiment, the receptacle connector assembly 104 may include one or more heat sinks (not shown) for dissipating heat from the pluggable communication module 200. For example, the heat sink may be coupled to the top wall 130 and extend through an opening in the top wall 130 to engage the pluggable communication module 200 and dissipate heat from the pluggable communication module 200.

In an exemplary embodiment, the receptacle connector 112 is received in the cavity 140, such as proximate to the rear wall 136. However, in alternative embodiments, the receptacle connector 112 may be located behind the rear wall 136 exterior of the receptacle cage 110 and extend into the cavity 140 to interface with the pluggable communication module(s) 200. In an exemplary embodiment, a single receptacle connector 112 is used. However, multiple receptacle connectors 112 may be used in other embodiments.

The receptacle connector 112 includes a housing 150 having a cavity 154 and a contact assembly 190 received in the cavity 154 of the housing 150. The contact assembly 190 includes an array of contacts 192 arranged in one or more rows. The contacts 192 are configured to be electrically connected to the pluggable communication module 200 when the pluggable communication module 200 is plugged into the housing 150.

The housing 150 extends between a front 156 and a rear 158. The cavity 154 is open at the rear 158 to receive the contact assembly 190. The housing 150 extends between a top 160 and a bottom 162. The housing 150 extends between opposite sides 168. The housing 150 may be generally box shaped in various embodiments. In the illustrated embodiment, the bottom 162 defines a mounting end configured to be mounted to the circuit board 102 (shown in FIG. 1) and the front 156 defines the mating end configured to be mated with the pluggable communication module 200 (shown in FIG. 1). Other orientations are possible in alternative embodiments, such as with the mating end at the top 160 and/or the mounting end at the rear 158.

The housing 150 includes one or more openings 170 at the mating end. The opening 170 is configured to receive a portion of the pluggable communication module 200. In an exemplary embodiment, the opening 170 is a card slot 172 configured to receive an edge of a circuit card. The contact assembly 190 is received in the housing 150 at the card slot 172 to mate with the pluggable communication module 200.

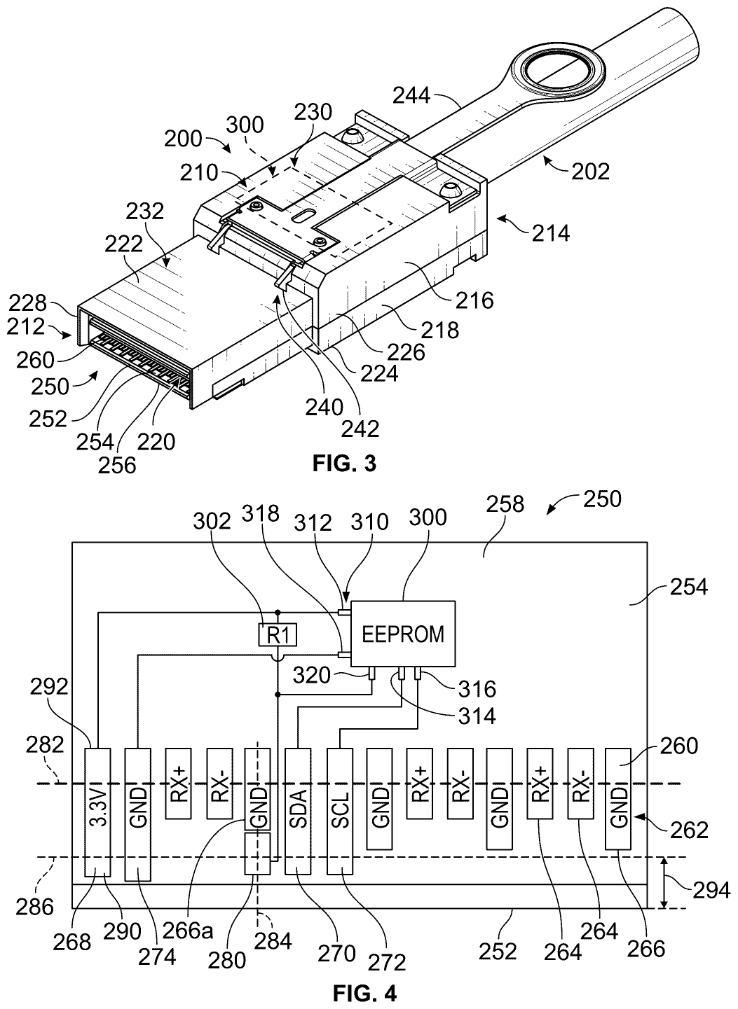

FIG. 3 is a front perspective view of the pluggable communication module 200 in accordance with an exemplary embodiment. In an exemplary embodiment, the pluggable communication module 200 is an input/output (I/O) module, such as a transceiver module. The pluggable communication module 200 includes a shell 210 holding a circuit card 250. A cable 202 is electrically connected to the circuit card 250. The cable 202 may include one or more wires or conductors terminated to the circuit card 250.

The circuit card 250 has an edge 252 at a mating end configured to be plugged into the receptacle connector 112, such as the card slot of the receptacle connector 112. The circuit card 250 includes contacts 260, such as pads or circuits, at the edge 252 configured to be mated with the receptacle connector 112. The contacts 260 may be provided on an upper surface 254 and/or a lower surface 256 of the circuit card 250. In an exemplary embodiment, the circuit card 250 includes a memory device 300 (shown in phantom) configured to store data associated with the pluggable communication module 200. The memory device may be an EEPROM device in various embodiments, and may be referred to hereinafter as EEPROM device 300. The memory device 300 is electrically connected to corresponding contacts 260.

The shell 210 extends between a mating end 212 and a cable end 214. The mating end 212 is configured to be mated with the receptacle connector 112. The cable 202 extends from the cable end 214. In the illustrated embodiment, the cable end 214 is opposite the mating end 212. For example, the mating end 212 may be located at a front of the shell 210 and the cable end 214 may be located at a rear of the shell 210. Other orientations are possible in alternative embodiments. For example, the pluggable communication module 200 may be a right-angle module having the cable end 214 perpendicular to the mating end 212.

In an exemplary embodiment, the shell 210 is a multipiece housing. For example, the shell 210 includes an upper shell member 216 and a lower shell member 218. The shell 210 includes a cavity 220 between the upper shell member 216 and the lower shell member 218. The shell 210 includes a top wall 222 and a bottom wall 224. The shell 210 includes side walls 226, 228 between the top wall 222 and the bottom wall 224. The upper and lower shell members 216, 218 may meet at a seam along the side walls 226, 228. In an exemplary embodiment, the shell 210 includes a main portion 230 and a nose 232 extending forward from the main portion 230. The nose 232 may be plugged into the module channel 116 of the receptacle cage 110 (shown in FIG. 1).

In an exemplary embodiment, the pluggable communication module 200 includes a latch 240 coupled to the shell 210. The latch 240 is used to secure the pluggable communication module 200 to the receptacle cage 110. The latch 240 includes one or more latch fingers 242 configured to be latchably coupled to the receptacle cage 110. In an exemplary embodiment, the latch 240 includes a release element 244 used to release the latch 240 from the receptacle cage 110 to remove the pluggable communication module 200 from the receptacle cage 110. For example, the release element 244 may include a pull tab or other type of release mechanism.

FIG. 4 illustrates the circuit card 250 in accordance with an exemplary embodiment. The circuit card 250 includes a substrate 258. The contacts 260 are provided on the substrate 258, such as the upper surface 254 and/or the lower surface 256. The EEPROM device 300 is mounted to the substrate 258, such as to the upper surface 254 and/or the lower surface 256. In an exemplary embodiment, other components are mounted to the substrate 258, such as a resistor 302 or other electrical components.

The EEPROM device 300 is a memory device that contains data associated with the pluggable communication module 200. For example, the EEPROM device 300 may include information including, but not limited to, serial numbers, manufacturer, manufacturer date, cable electrical performance data, type of cable, the length of cable, cable loss profile, number of contacts, and the like. The data stored in the EEPROM device 300 is configured to be write protected. However, the circuit card 250 may be configured for use in a write enable mode (for example, programming mode) to enter data or modify data stored on the EEPROM device 300. In normal operation, the circuit card 250 is in a write disabled mode (for example, write protected mode).

The EEPROM device 300 includes a plurality of conductors 310, such as leads, contacts or pins, configured to be electrically connected to circuits of the circuit card 250. For example, the conductors 310 may be soldered to pads or traces on the circuit card 250. In an exemplary embodiment, the EEPROM device 300 includes a power supply pin 312, a serial data pin 314, a serial clock pin 316, a programming ground pin 318, and a write control pin 320. The EEPROM device 300 may include additional pins in alternative embodiments, such as address inputs.

The contacts 260 of the circuit card 250 form a contact pad field 262 along the upper surface 254 and/or the lower surface 256 (not shown). The contacts 260 are configured to be mated with the corresponding contacts 192 of the receptacle connector 112. The contacts 260 include pads, traces, vias, or other circuit elements extending along one or more surfaces and/or layers of the circuit card 250.

In an exemplary embodiment, the contacts 260 includes signal pads 264 and ground pads 266. The ground pads 266 may be arranged between the signal pads 264 to provide shielding or isolation between the signal pads 264. In an exemplary embodiment, the signal pads 264 are arranged in pairs with the ground pads 266 between the pairs of the signal pads 264. For example, the pair of signal pads 264 may define a differential pair configured to transmit and/or receive differential signals.

In an exemplary embodiment, the contacts 260 include one or more power pads 268. The power pad 268 is used to supply power to the EEPROM device 300. For example, the power pad 268 is electrically connected to the power supply pin 312 of the EEPROM device 300. The power pad 268 may supply a voltage, such as 3.3 V, 5.0 V, or another voltage to the EEPROM device 300.

In an exemplary embodiment, the contacts 260 include a serial data pad 270 and a serial clock pad 272. The serial data pad 270 is configured to be electrically connected to the serial data pin 314 of the EEPROM device 300. The serial clock pad 272 is configured to be electrically connected to the serial clock pin 316 of the EEPROM device 300.

In an exemplary embodiment, at least one of the ground pads 266 of the contacts 260 include a programming ground pad 274. The programming ground pad 274 is configured to be electrically connected to the ground pin 318 of the EEPROM device 300.

In an exemplary embodiment, the contacts 260 include a write pad 280 used to disable the write protection of the EEPROM device 300 and allow the EEPROM device 300 to enter the write enable mode for programming the EEPROM device 300. The write pad 280 is configured to be electrically connected to the write control pin 320 of the EEPROM device 300. In an exemplary embodiment, the write pad 280 is electrically connected to the power pad 268 by the resister 302.

In an exemplary embodiment, the contacts 260 in the contact pad field 262 are arranged in a row (along a lateral axis 282) proximate to the edge 252 of the circuit card 250. For example, the signal pads 264, the ground pads 266, the power pad 268, the serial data pad 270, and the serial clock pad 272 may be arranged in the row. In various embodiments, the write pad 280 may be arranged in the row. However, in other various embodiments, the write pad 280 may be offset from the row, such as being staggered or stacked with another one of the contacts 260. In the illustrated embodiment, the write pad 280 is stacked with a first ground pad of the ground pads 266, referred to hereinafter as a stacked ground pad 266a. As such, the write pad 280 and the stacked ground pad 266a are configured to interface with the same contact 192 of the receptacle connector 112. By utilizing the same contact 192 for the write pad 280 and the stacked ground pad 266a, the contact pad field 262 does not need to add an additional contact, and thus the receptacle connector 112 does not need to add an additional contact 192. As such, the overall interface may be reduced, saving space and/or cost. Additionally, the circuit card 250 incorporating the write pad 280 may be usable with receptacle connectors 112 having a standard mating interface (for example, a standard number of contacts).

In an exemplary embodiment, each contact 260 extends between a front end 290 and a rear end 292. The contacts 260 have lengths defined between the front end 290 and the rear end 292 of the respective contact 260. The contacts 260 extend along contact axes between the front end 290 and the rear end 292. In an exemplary embodiment, the contacts 260 within the contact pad field 262 are arranged parallel to each other. The contacts 260 have gaps or spacings between the contacts 260. Optionally, the spacings between the contacts 260 may be the same across the contact pad field 262. However, the spacings may be different between various contacts 260. In an exemplary embodiment, the contacts 260 may have various lengths, such as for sequential mating. For example, the power pad 268, the serial data pad 270, the serial clock pad 272, and the programming ground pad 274 may have a first length. The other ground pads 266 may have a second length shorter than the first length. The signal pads 264 may have a third length shorter than the second length. In other various embodiments, all of the ground pads 266 may have the first length. In other various embodiments, the power pad 268 may be longer than other pads, such as being longer than the serial data pad 270 and the serial clock pad 272. The programming ground pad 274 may be longer than the power pad 268 and/or longer than the serial data pad 270 and the serial clock pad 272. The different lengths of the contact 260 allow for sequential mating with the various contacts 260 as the circuit card 250 is plugged into the receptacle connector 112.

In the illustrated embodiment, the rear ends 292 of the contacts 260 are aligned at the same depth from the edge 252 of the circuit card 250. However, the front ends 290 of the various contacts 260 are staggered at different depths from the edge 252 of the circuit card 250. For example, the power pad 268, the serial data pad 270, the serial clock pad 272, and the programming ground pad 274 may be located closer to the edge 252 than the signal pads 264 and/or the other ground pads 266. As such, the power pad 268, the serial data pad 270, the serial clock pad 272, and the programming ground pad 274 may be mated with the corresponding contact 192 of the receptacle connector 112 prior to mating of the signal pads 264 and/or the other ground pads 266 with their corresponding contacts 192. Optionally, one or more of the ground pads 266 may be closest to the edge 252 (for example, having the shortest depth) to ensure that the circuit card 250 is grounded prior to mating to other pads, such as the power pad 268. In the illustrated embodiment, the contacts 260 have a mating sequence of one of the ground pads 266 and the write pad 280 mating first, the power pad 268 mating second, the serial data pad 270 and the serial clock pad 272 mating third and the signal pads 264 mating last. Other arrangements are possible in alternative embodiments.

In an exemplary embodiment, the write pad 280 is located forward of the stacked ground pad 266a, such as between the ground pad 266 and the edge 252. For example, the write pad 280 is longitudinally aligned with the ground pad 266 (along a longitudinal axis 284), but located forward of the ground pad 266. The write pad 280 may be laterally aligned (along a lateral axis 286) with the front portions of the power pad 268, the serial data pad 270, the serial clock pad 272, and the programming ground pad 274 at a first depth 294 from the edge 252. As such, when the circuit card 250 is partially loaded into the receptacle connector 112, only the power pad 268, the serial data pad 270, the serial clock pad 272, the programming ground pad 274 and the write pad 280 may be connected to their corresponding contact 192, whereas the signal pads 264 remain unmated to their corresponding contact 192. The write enable mode is utilized in such partial mated condition to allow programming of the EEPROM device 300.

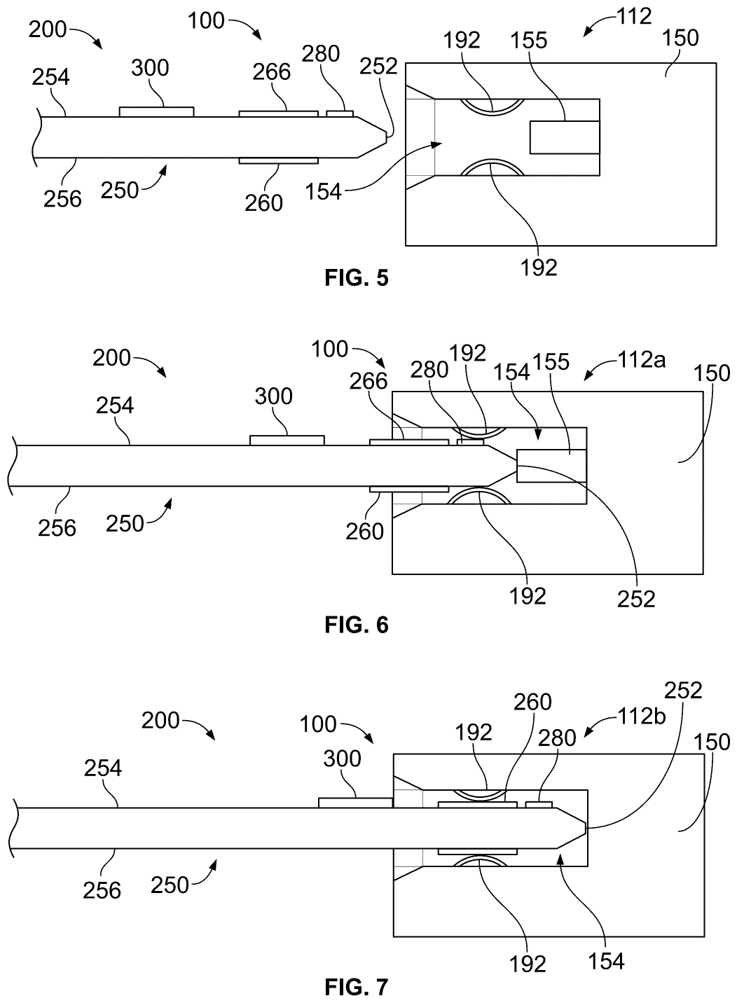

FIG. 5 is a sectional view of the communication system 100 in accordance with an exemplary embodiment showing the circuit card 250 of the pluggable communication module 200 poised for loading into the receptacle connector 112. FIG. 6 is a sectional view of the communication system 100 in accordance with an exemplary embodiment showing the circuit card 250 of the pluggable communication module 200 partially loaded into the receptacle connector 112 to a programming depth. FIG. 7 is a sectional view of the communication system 100 in accordance with an exemplary embodiment showing the circuit card 250 of the pluggable communication module 200 loaded into the receptacle connector 112 to a full mate depth.

In an exemplary embodiment, the communication system 100 may utilize a testing or programming receptacle connector 112a for testing the pluggable communication module 200 and/or programming the EEPROM device 300. The programming receptacle connector 112a is shown in FIGS. 5 and 6. The programming receptacle connector 112a utilizes a stop block 155 to control a mating position of the circuit card 250 relative to the receptacle connector 112. In the illustrated embodiment, the stop block 155 extends into the cavity 154 of the housing 150 to interface with the edge 252 of the circuit card 250 to position the circuit card 250 in the housing 150. The stop block 155 may be located at other positions in alternative embodiments for example, the stop block 155 may extend from the front of the housing 150 to interface with another portion of the circuit card 250. In other various embodiments, the stop block 155 may extend from the cage 110 (shown in FIG. 1) to interface with the circuit card 250 and control the mating taps of the circuit card 250. The stop block 155 limits plugging of the circuit card 250 into the housing 150 to the programming depth. The stop block 155 prevents the circuit card 250 from plugging the circuit card 250 into the housing 150 to the full mate depth. In an exemplary embodiment, the communication system 100 may utilize a normal receptacle connector 112b for normal operation within the communication system 100. The normal receptacle connector 112b does not include the stop block 155. The normal receptacle connector 112b allows the circuit card 250 plugged into the housing 150 to the full mate depth. Optionally, the stop block 155 may be removable from the housing 150 to transform the receptacle connector 112 from the programming receptacle connector 112a to the normal receptacle connector 112b.

In an exemplary embodiment, the receptacle connector 112 includes the contacts 192 along both sides of the card slot (for example, along the top and the bottom of the card slot). Similarly, the circuit card 250 includes the contacts 260 along both the upper surface 254 and the lower surface 256.

In an exemplary embodiment, the write pad 280 is located at the front of the circuit card 250 proximate to the edge 252. The write pad 280 is located forward of the ground pad 266. The write pad 280 is positioned along the upper surface 254 to interface with the corresponding contact 192 at the programming depth (FIG. 6). For example, when the circuit card 250 is partially loaded into the card slot of the housing 150, the write pad 280 is electrically connected to the corresponding contact 192 to cause the pluggable communication module 200 to operate in the write enable mode. When the ground pad 266 is connected to the contact 192, the pluggable communication module 200 is in the write disabled mode (for example, write protected mode). For example, when the circuit card 250 is at the full mate depth, the contact 192 interfaces with the signal pads 264 and the ground pads 266 and do not interface with the write pad 280. As such, at the full mate depth, the pluggable communication module 200 is in the write disabled mode.

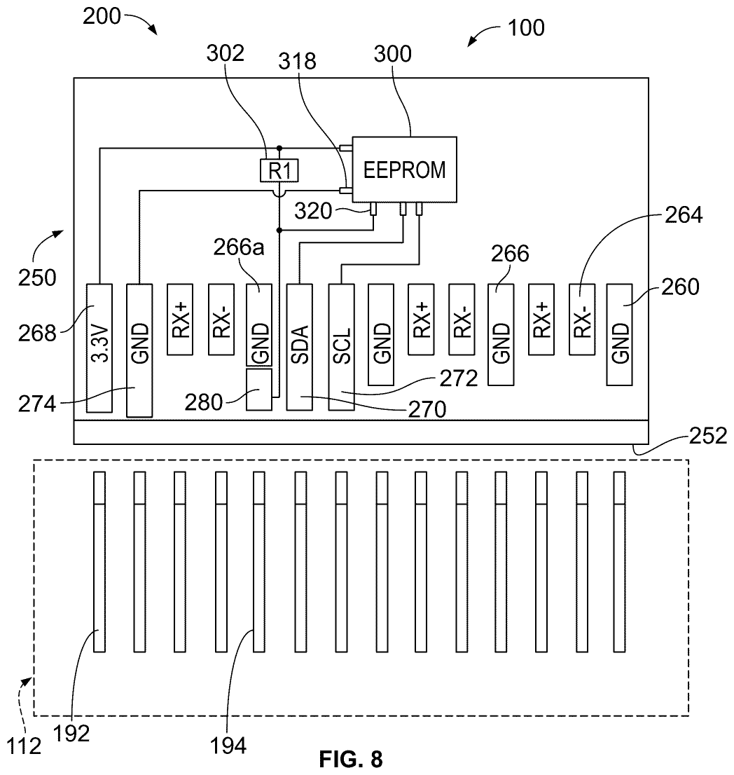

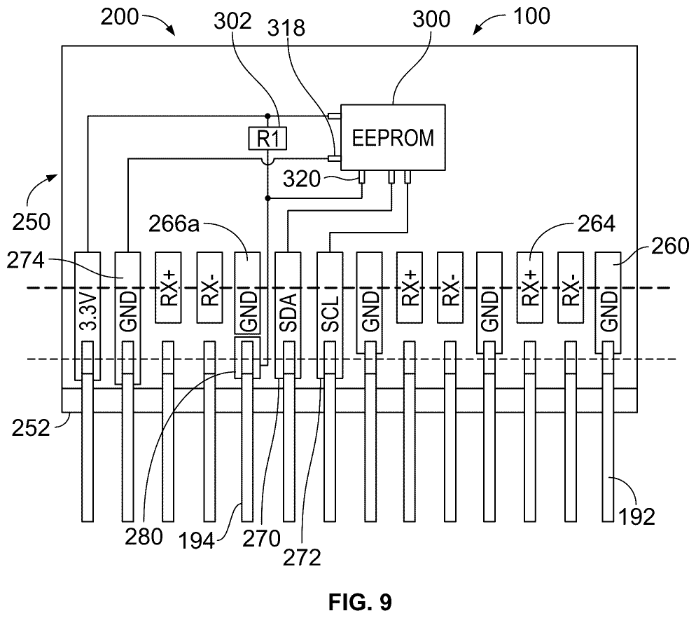

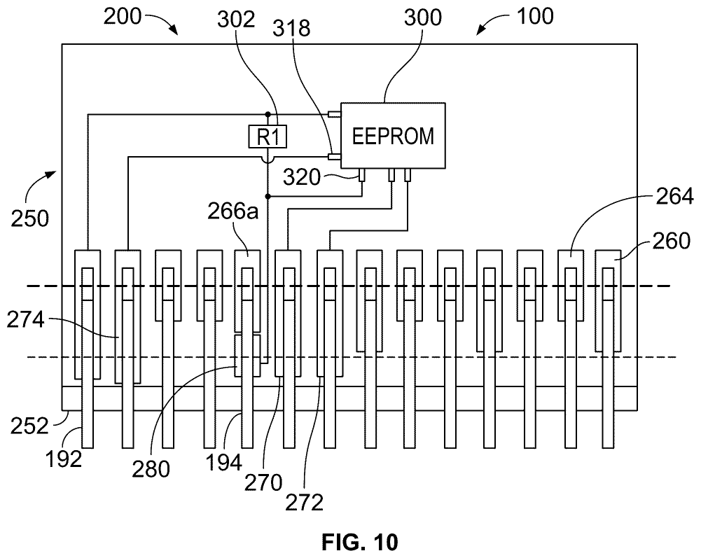

FIG. 8 is a top view of the communication system 100 in accordance with an exemplary embodiment showing the circuit card 250 of the pluggable communication module 200 unmated with the contact array of contacts 192 of the receptacle connector 112 (corresponding to FIG. 5). FIG. 9 is a top view of the communication system 100 in accordance with an exemplary embodiment showing the circuit card 250 of the pluggable communication module 200 partially mated with the contact array of contacts 192 of the receptacle connector 112 at the programming depth (corresponding to FIG. 6). FIG. 10 is a top view of the communication system 100 in accordance with an exemplary embodiment showing the circuit card 250 of the pluggable communication module 200 mated with the contact array of contacts 192 of the receptacle connector 112 at the full mate depth (corresponding to FIG. 7).

In an exemplary embodiment, the array of contacts 192 of the receptacle connector 112 are arranged in a row at a predetermined spacing corresponding to the spacing of the contact 260. The contacts 192 include signal contacts, ground contacts, a power contact, a serial data contact, and a serial clock contact corresponding to the signal pads 264, the ground pads 266, the power pad 268, the serial data pad 270, and the serial clock pad 272 of the circuit card 250. The signal pads 264, the ground pads 266, the power pad 268, the serial data pad 270, and the serial clock pad 272 are located at a full mate depth from the edge 252 of the circuit card 250 to mate with the corresponding contacts 192 at the full mate depth. The write pad 280 is short of the full mate depth, but rather is only configured to mate to the corresponding contact 192 at the programming depth along with the power pad 268, the serial data pad 270, the serial clock pad 272, and the programming ground pad 274. The contacts 192 of the receptacle connector 112 interfacing with the power pad 268, the serial data pad 270, the serial clock pad 272, and the programming ground pad 274 are configured to interface with the power pad 268, the serial data pad 270, the serial clock pad 272, and the programming ground pad 274 when the circuit card 250 is loaded to the programming depth and when the circuit card 250 is loaded to the full mate depth.

In an exemplary embodiment, one of the contacts 192 defines a programming contact 194 configured to interface with the write pad 280 when the circuit card 250 is at the programming depth (FIG. 9). The same programming contact 194 is configured to mate with one of the ground pads 266 when the circuit card 250 is at the full mate depth (FIG. 10). As such, the communication system 100 does not require any additional components to be added to the receptacle connector 112 (for example, additional contact 192), which reduces cost compared to systems having additional components.

In an exemplary embodiment, when the circuit card 250 is at the programming depth, the contacts 192 are configured to interface with the power pad 268, the serial data pad 270, the serial clock pad 272, the programming ground pad 274, and the write pad 280 to cause the EEPROM device 300 to operate in the write enable mode. The data on the EEPROM device 300 may be entered, deleted, updated, modified, and the like in the write enable mode. The write pad 280 is electrically connected to the power supply by the resister 302. The write enable circuit uses the write pad 280 to ground the power supply connection to the write control pin 320. The EEPROM device 300 is write enabled when the signal to the write control pin 320 is driven low or left floating. When the write pad 280 is disconnected from the contact 192, the write control pin 320 is driven high (for example, 3.3 V) and the EEPROM device 300 is write protected.

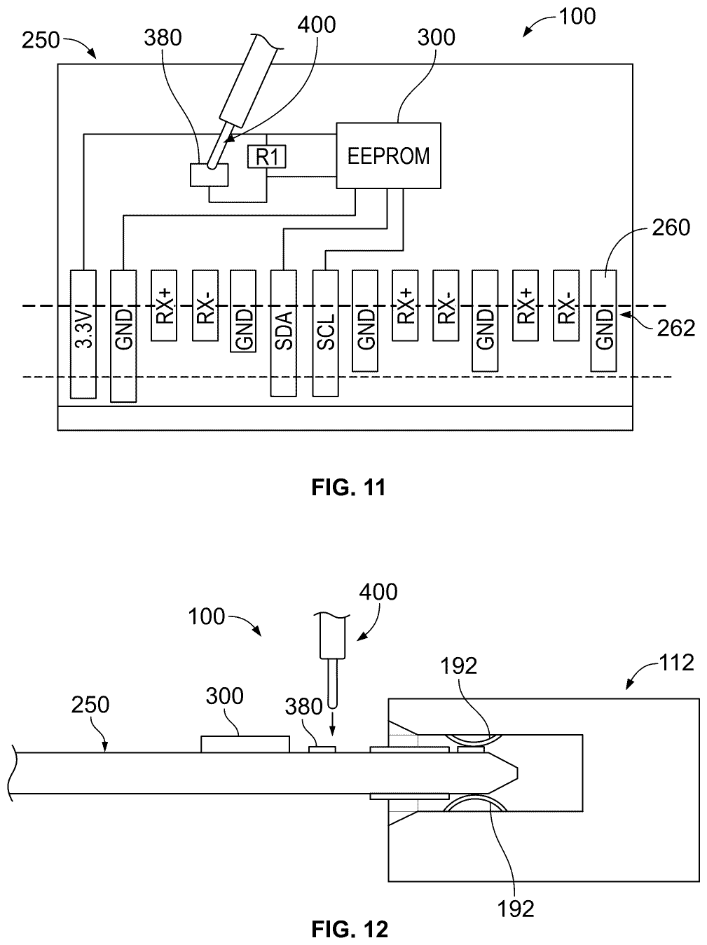

FIG. 11 illustrates the circuit card 250 in accordance with an exemplary embodiment showing a different arrangement of the contacts 260. FIG. 12 is a sectional view of the communication system 100 in accordance with an exemplary embodiment showing the circuit card 250 of FIG. 11 partially loaded into the receptacle connector 112 to a programming depth. In the illustrated embodiment, the write pad 380 is located at a location remote from the contact pad field 262, such as at a location near the EEPROM device 300. In an exemplary embodiment, a programming probe 400 is configured to interface with the write pad 380 to enable writing to the EEPROM device 300. The programming probe 400 may be handheld or may be part of a testing fixture configured to interface with the write pad 380 during the testing or programming mode. In the illustrated embodiment, the write pad 380 does not interface with the contacts 192 of the receptacle connector 112. The EEPROM device 300 is configured to be programmed when the circuit card 250 is mated with the receptacle connector 112 in a write enabled mode. The EEPROM device 300 is configured to be restricted from programming when the circuit card 250 is mated with the receptacle connector 112 in a write disabled mode.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. A pluggable communication module configured to be plugged into a receptacle connector, the pluggable communication module comprising:
a circuit card including a substrate having an upper surface and a lower surface, the substrate having an edge;
an EEPROM device mounted to the upper surface of the substrate, the EEPROM device including a power supply pin, a serial data pin, a serial clock pin, a ground pin, and a write control pin for programming the EEPROM device; and
a contact pad field on the upper surface of the substrate proximate to the edge, the contact pad field including signal pads, ground pads, a power pad, a serial data pad, a serial clock pad, and a write pad;
wherein the power pad is electrically connected to the power supply pin of the EEPROM device, the serial data pad is electrically connected to the serial data pin of the EEPROM device, the serial clock pad is electrically connected to the serial clock pin of the EEPROM device, a programming ground pad of the ground pads is electrically connected to the ground pin of the EEPROM device, and the write pad is electrically connected to the write control pin of the EEPROM device;
wherein the write pad is located at a programming depth from the edge of the circuit card forward of the signal pads to mate the write pad to the receptacle connector without mating to the signal pads to the receptacle connector.

2. The pluggable communication module of claim 1, wherein the write pad is aligned in a mating direction with a first ground pad of the ground pads.

3. The pluggable communication module of claim 2, wherein the write pad is configured to electrically connect to a first contact of the receptacle connector in a programming mode, the first ground pad being isolated from the first contact in the programming mode, and wherein the first ground pad is configured to electrically connect to the first contact of the receptacle connector in a normal operating mode, the write pad being isolated from the first contact in the normal operating mode.

4. The pluggable communication module of claim 1, wherein the write pad is connected to the power pad through a resistor.

5. The pluggable communication module of claim 1, wherein the EEPROM device is configured to be programmed when the circuit card is mated with the receptacle connector in a write enabled mode, and wherein the EEPROM device is configured to be restricted from programming when the circuit card is mated with the receptacle connector in a write disabled mode.

6. The pluggable communication module of claim 1, wherein the signal pads, the ground pads, the power pad, the serial data pad, and the serial clock pad are located at a full mate depth from the edge of the circuit card, the write pad being short of the full mate depth.

7. The pluggable communication module of claim 1, wherein the power pad, the serial data pad, and the serial clock pad have a first length, the ground pads have a second length less than the first length, and the signal pads have a third length less than the second length.

8. The pluggable communication module of claim 1, wherein the signal pads, the ground pads, the power pad, the serial data pad, and the serial clock pad are arranged in a row and extend parallel to each other in a direction parallel to a mating direction, the write pad positioned forward of the row and aligned with one of the ground pads in the mating direction.

9. The pluggable communication module of claim 1, wherein the power pad, the serial data pad, the serial clock pad, and the programming ground pad are aligned with the write pad at the programming depth from the edge of the circuit card forward of the signal pads to mate the power pad, the serial data pad, the serial clock pad, the programming ground pad, and the write pad to the receptacle connector without mating to the signal pads to the receptacle connector.

10. The pluggable communication module of claim 1, wherein the circuit card is configured to physically engage a stop block of the receptacle connector to control a mating position of the circuit card relative to the receptacle connector to connect the power pad, the serial data pad, the serial clock pad, and the write pad to the contacts of the receptacle connector at the programming depth to enable programming of the EEPROM device and restrict connecting of the signal pads with the contacts of the receptacle connector.

11. A pluggable communication module configured to be plugged into a receptacle connector, the pluggable communication module comprising:
a circuit card including a substrate having an upper surface and a lower surface, the substrate having an edge;
an EEPROM device mounted to the upper surface of the substrate, the EEPROM device including a power supply pin, a serial data pin, a serial clock pin, a ground pin, and a write control pin for programming the EEPROM device; and
a contact pad field on the upper surface of the substrate proximate to the edge, the contact pad field including signal pads, ground pads, a power pad, a serial data pad, a serial clock pad, and a write pad;
wherein the power pad is electrically connected to the power supply pin of the EEPROM device, the serial data pad is electrically connected to the serial data pin of the EEPROM device, the serial clock pad is electrically connected to the serial clock pin of the EEPROM device, a programming ground pad of the ground pads is electrically connected to the ground pin of the EEPROM device, and the write pad is electrically connected to the write control pin of the EEPROM device;
wherein the power pad, the serial data pad, the serial clock pad, and the programming ground pad are located at a programming depth from the edge of the circuit card forward of the signal pads to mate the power pad, the serial data pad, and the serial clock pad to the receptacle connector without mating to the signal pads to the receptacle connector;
wherein the write pad is configured to mate with a programming probe to program the EEPROM device.

12. The pluggable communication module of claim 10, wherein the EEPROM device is configured to be programmed when the circuit card is mated with the receptacle connector in a write enabled mode, and wherein the EEPROM device is configured to be restricted from programming when the circuit card is mated with the receptacle connector in a write disabled mode.

13. A communication system comprising:
a receptacle connector including a connector housing having a cavity, contacts received in the cavity and held by the housing, each contact including a contact beam having a mating interface, the mating interfaces of the contacts being arranged in a row, the connector housing including an opening to the cavity;
a pluggable communication module plugged into the opening to mate with the contacts, the pluggable communication module comprising:
a circuit card including a substrate having an upper surface and a lower surface, the substrate having an edge configured to be plugged into the opening of the connector housing;
an EEPROM device mounted to the upper surface of the substrate, the EEPROM device including a power supply pin, a serial data pin, a serial clock pin, a ground pin, and a write control pin for programming the EEPROM device; and
a contact pad field on the upper surface of the substrate proximate to the edge, the contact pad field including signal pads, ground pads, a power pad, a serial data pad, a serial clock pad, and a write pad configured to be mated with the contacts when the pluggable communication module is plugged into the receptacle connector;
wherein the power pad is electrically connected to the power supply pin of the EEPROM device, the serial data pad is electrically connected to the serial data pin of the EEPROM device, the serial clock pad is electrically connected to the serial clock pin of the EEPROM device, a programming ground pad of the ground pads is electrically connected to the ground pin of the EEPROM device, and the write pad is electrically connected to the write control pin of the EEPROM device;
wherein the write pad is located at a programming depth from the edge of the circuit card forward of the signal pads;
wherein the pluggable communication module is pluggable into the opening to a programming position to mate the write pad to the receptacle connector without mating to the signal pads to the receptacle connector.

14. The communication system of claim 13, wherein the write pad is aligned in a mating direction with a first ground pad of the ground pads.

15. The communication system of claim 14, wherein the write pad is configured to electrically connect to a first contact of the receptacle connector in a programming mode, the first ground pad being isolated from the first contact in the programming mode, and wherein the first ground pad is configured to electrically connect to the first contact of the receptacle connector in a normal operating mode, the write pad being isolated from the first contact in the normal operating mode.

16. The communication system of claim 13, wherein the contacts of the receptacle connector include a programming contact configured to interface with the write pad when the circuit card is loaded to a programming depth and configured to interface one of the ground pads when the circuit card is loaded to a full mate depth.

17. The communication system of claim 16, wherein the contacts of the receptacle connector interfacing with the power pad, the serial data pad, the serial clock pad are configured to interface with the power pad, the serial data pad, the serial clock pad when the circuit card is loaded to the programming depth and when the circuit card is loaded to the full mate depth.

18. The communication system of claim 13, wherein the write pad is connected to the power pad through a resistor.

19. The communication system of claim 13, wherein the EEPROM device is configured to be programmed when the circuit card is mated with the receptacle connector in a write enabled mode, and wherein the EEPROM device is configured to be restricted from programming when the circuit card is mated with the receptacle connector in a write disabled mode.

20. The communication system of claim 13, wherein the signal pads, the ground pads, the power pad, the serial data pad, and the serial clock pad are located at a full mate depth from the edge of the circuit card, the write pad being short of the full mate depth.
